(19) United States
(12) Patent Application Publication
(10) Pub. No.: US 2017/0030736 A1
(43) Pub. Date: Feb. 2, 2017

(54) PHOTOVOLTAIC POWER STATION REMOTE MONITORING SYSTEM

(71) Applicants: BOE TECHNOLOGY GROUP CO., LTD., Beijing (CN); BEIJING BOE ENERGY TECHNOLOGY CO., LTD., Beijing (CN)

(72) Inventors: Jianzhong Yang, Beijing (CN); Xiaoyan Han, Beijing (CN); Nan Zhang, Beijing (CN); Hangbin Song, Beijing (CN)

(21) Appl. No.: 15/082,945

(22) Filed: Mar. 28, 2016

(30) Foreign Application Priority Data
Jul. 30, 2015 (CN) 201510460002.3

(51) Int. Cl. G01D 4/00

(52) U.S. Cl. CPC G01D 4/002

(57) ABSTRACT

The present invention provides a photovoltaic power station remote monitoring system, comprising a monitoring center system and at least one monitoring terminal system; each monitoring terminal system is used for collecting operating parameters of a photovoltaic power station to which it belongs, and sending the operating parameters to the monitoring center system via a telecommunication network; the monitoring center system is used for receiving and displaying the operating parameters sent from respective monitoring terminal systems. For the monitoring personnel, a remote monitoring of respective PV power stations may be achieved only at the monitoring center system, which facilitates the monitoring.

### CROSS-REFERENCE TO RELATED APPLICATION

This application claims the benefit of Chinese Patent Application No. 201510460002.3 filed on Jul. 30, 2015 in the State Intellectual Property Office of China, the whole disclosure of which is incorporated herein by reference.

### FIELD OF THE INVENTION

Embodiments of the present invention relate to the field of photovoltaic (PV) technology, and especially to a photovoltaic power station remote monitoring system.

### BACKGROUND OF THE INVENTION

In recent years, the photovoltaic power stations of large scale have been begun to be constructed and put into operation. According to the installation capacity, photovoltaic power stations can be classified into large-scale ground PV power stations and small- and medium-sized rooftop PV power stations. According to different construction forms, they can also be classified into off-grid PV power stations, user side grid-connected power stations, etc. Large-scale ground photovoltaic power stations are generally built in remote areas with harsh natural conditions, and small- and medium-sized rooftop power stations are located on the surface of the roof where space is limited. How to achieve monitoring these PV stations easily has become an urgent problem.

### SUMMARY OF THE INVENTION

The present invention has been made to overcome or alleviate at least one aspect of the above described disadvantages.

Accordingly, it is an object of the present invention to provide a photovoltaic power station remote monitoring system comprising: a monitoring center system and at least one monitoring terminal system;

each monitoring terminal system is used for collecting operating parameters of a photovoltaic power station to which it belongs, and sending the operating parameters to the monitoring center system via a telecommunication network; and

the monitoring center system is used for receiving and displaying the operating parameters sent from respective monitoring terminal systems.

Preferably, the monitoring terminal systems are used for receiving operating parameters of photovoltaic power stations collected by a plurality of collection equipments via a fieldbus.

Preferably, the monitoring terminal systems are used for sending the collected operating parameters to the monitoring center system with a layer-3 tunnel encryption protocol (IPsec).

Preferably, the monitoring center system is used for displaying the received operating parameters by way of a chart.

Preferably, the monitoring center system is further used for comparing the operating parameters of the same kind which are sent from respective monitoring terminal systems, and displaying results of comparison.

Preferably, the monitoring center system is further used for analysing the operating parameters sent from respective monitoring terminal systems according to preset analysis rules and displaying results of analysis.

Preferably, the monitoring center system is further used for determining a failure by using the operating parameters sent from respective monitoring terminal systems according to preset failure determination rules and outputting an alarm when it detects a failure.

Preferably, the monitoring center system is further used for receiving operating parameters editing commands input by a user and editing corresponding operating parameters according to received operating parameters editing commands.

Preferably, the telecommunication system is a wireless communication system.

Preferably, the monitoring center system is further used for receiving controlling commands to collection equipments input by a user and sending the received controlling commands to the monitoring terminal system to which a target collection equipment is connected; and the monitoring terminal systems are further used for sending the received controlling command to the target collection equipment.

The PV power station remote monitoring system of embodiments of the present invention includes monitoring terminal systems and a monitoring center system. The monitoring terminal system is capable of collecting operating parameters of a photovoltaic power station to which the monitoring terminal system belongs, and sending the operating parameters to the monitoring center system. The monitoring center system displays the received operating parameters. Thus, for the monitoring personnel, a remote monitoring of respective PV power stations may be achieved only at the monitoring center system, which facilitates the monitoring.

### BRIEF DESCRIPTION OF THE DRAWINGS

FIG. 1 is an illustrative view of an arrangement of a PV power station remote monitoring system according to an embodiment of the present invention;

FIG. 2 is an illustrative view of an arrangement of a monitoring terminal system of a PV power station remote monitoring system according to an embodiment of the present invention;

FIG. 3 is an illustrative view of an arrangement of another PV power station remote monitoring system according to an embodiment of the present invention; and

FIG. 4 is an illustrative view of an arrangement of a part of a monitoring central system of a PV power station remote monitoring system according to an embodiment of the present invention.

### DETAILED DESCRIPTION OF PREFERRED EMBODIMENTS OF THE INVENTION

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

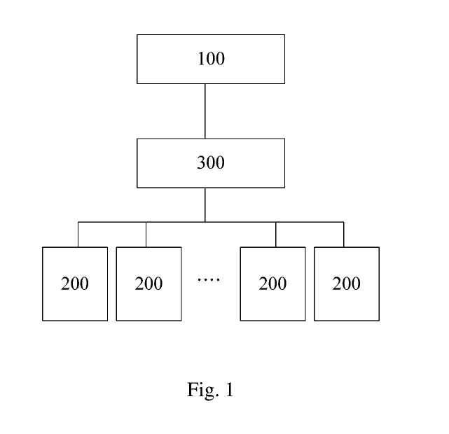

Embodiments of the present disclosure provide a photovoltaic power station remote monitoring system is provided in present invention, as shown in FIG. 1, which comprises: a monitoring center system 100 and a plurality of monitoring terminal systems 200;

each monitoring terminal system 200 is used for collecting operating parameters of a photovoltaic power station to which it belongs, and sending the operating parameters to the monitoring center system 100 via a telecommunication network 300; and

the monitoring center system 100 is used for receiving and displaying the operating parameters sent from respective monitoring terminal systems 200.

The PV power station remote monitoring system of the present invention includes monitoring terminal systems and a monitoring center system. The monitoring terminal system is capable of collecting operating parameters of a photovoltaic power station to which it belongs, and sending the operating parameters to the monitoring center system. The monitoring center system displays the received operating parameters. Thus, a remote monitoring of respective PV power stations may be achieved by the monitoring personnel only at the monitoring center system, which facilitates the monitoring.

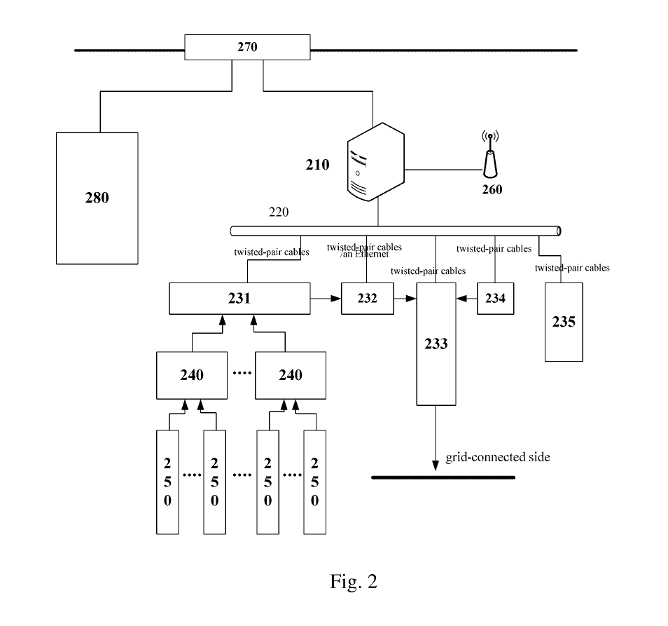

When being implemented, the monitoring terminal systems 200 are specifically used for receiving operating parameters of photovoltaic power stations collected by a plurality of collection equipments via a fieldbus and sending the operating parameters to the monitoring center system via a telecommunication network. Referring to FIG. 2, an alternative illustrative view of the arrangement of an monitoring terminal system 200 is shown, which comprises: a data collection server 210 connected to a plurality of collection equipments 231-235 via a fieldbus 220. The collection equipment 231 is for example a lightning protection DC power distribution cabinet which is connected to the fieldbus 220 via twisted-pair cables. The lightning protection DC power distribution cabinet is connected to PV combiner boxes 240, and each of the PV combiner box 240 is connected to a plurality of battery packs 250. The collection equipment 232 is an inverter which is connected with the collection equipment 231 and is connected to the fieldbus 220 via twisted-pair cables or an Ethernet. The collection equipment 233 is an AC power distribution cabinet which is connected with the inverter 232 and is connected to the fieldbus 220 via twisted-pair cables. The electric current flows into the grid via the AC power distribution cabinet. The collection equipment 234 is an ammeter which is connected with the AC power distribution and is connected to the fieldbus 220 via twisted-pair cables. The collection equipment 235 is an aerograph which is connected to the fieldbus 220 via twisted-pair cables. In an example, the above described telecommunication network may be a wireless communication network or a wired communication network. When it is a wireless communication network, the above described monitoring terminal system 200 generally further comprises a wireless communication module 260. The data collection server 210 is connected to the wireless communication module 260 and communicates the operating parameters to the monitoring central system 100 via the wireless communication module 260. When it is a wired communication network, the above described monitoring terminal system 200 generally further comprises a wired communication module 270 (such as fiber optic transceivers, etc.), and communicates the operating parameters to the monitoring central system 100 via the wired communication module 270. In addition, the monitoring terminal system 200 may also include a security server 280.

Specifically, when the above described telecommunication network 300 is a wired communication network, it may be specifically a fiber-optic communications network. For example, a 100M/1000M single-mode fiber may be used as the physical medium of the fiber optic ring network. The communication protocol may be a TCP/IP protocol. In this way, it enables the operating parameters to be transmitted with a fast speed, a good real-time performance and reliability.

When being implemented, the monitoring terminal systems are specifically used for sending the collected operating parameters to the monitoring center system with an IPsec tunnel protocol.

IPsec (IP security) is a layer-3 tunnel encryption protocol defined by IETF, which may provide the data transmitted over Internet with an interoperable and cryptology-based security guarantee of high quality. Sending the collected operating parameters to the monitoring center system with the IPsec tunnel protocol may make the collected operating parameters to be sent to the monitoring center system safely.

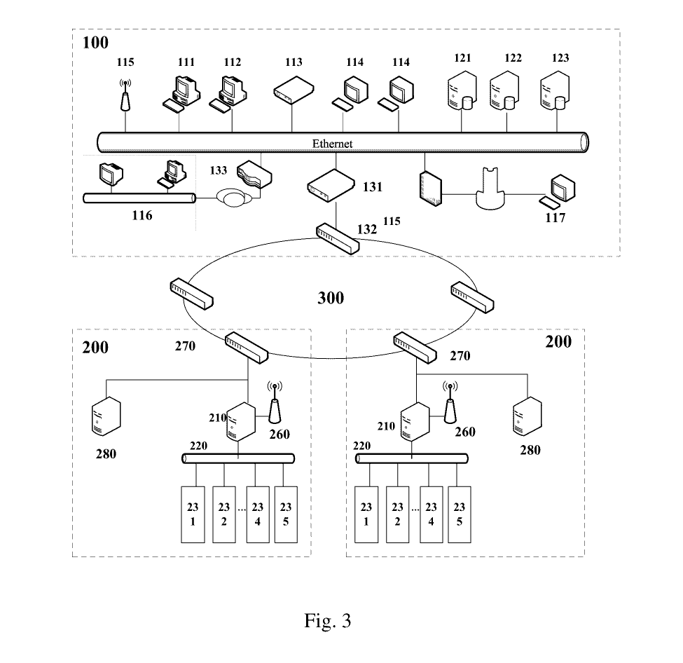

When being implemented, see FIG. 3, the above described monitoring center system 100 may comprises a scheduling workstation 111, a management station 112, a power prediction workstation 113, a operator workstation 114, a GPS system 115, an EMS (Energy Management System) scheduling system 116, a remote workstation 117, a data application server 121, a database server 122, a backup server 123, and the like. Respective workstations are connected via an Ethernet which is connected to the communication network 300 via a communication front-end processor 131 and an optical switch 132. The EMS scheduling system is connected to Ethernet via a router 133.

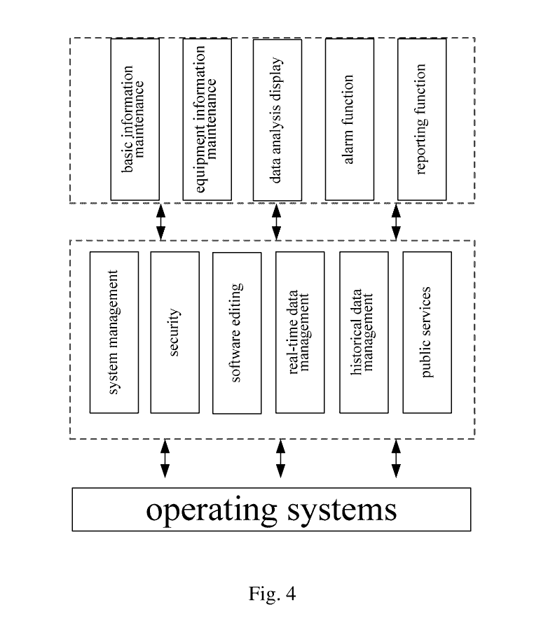

When being implemented, see FIG. 4, the above described monitoring terminal system may be integrated with one or more functions. Specifically, operating systems and monitoring software may be installed on hosts of respective workstations. The monitoring software may have one or several of the following functions:

basic information maintenance, equipment information maintenance, data analysis display, alarm function, reporting function, system management, security, software editing, real-time data management, historical data management, public services and other functions.

When being implemented, the monitoring center system is further used for analysing the operating parameters sent from respective monitoring terminal systems according to preset analysis rules and displaying results of analysis so as to achieve the above described function of data analysis display.

In this way, some analysis to the operating parameters can be performed automatically, saving manual labor.

Further, when being implemented, the monitoring center system 100 may be specifically used for displaying the received operating parameters by way of a chart.

In this way, operating parameters may be displayed to the monitoring personnel friendly and visually, which enable operating parameters of PV power station, such as power generation output and equipment failure, to be clear at a glance.

When being implemented, the monitoring center system may be used for determining a failure by using the operating parameters sent from respective monitoring terminal systems according to preset failure determination rules and outputting an alarm when it detects a failure.

In this way, it may timely warn the monitoring personnel of a failure, saving manual labor of failure determination.

When being implemented, the monitoring center system is further used for receiving operating parameters editing commands input by a user and editing corresponding operating parameters according to received operating parameters editing commands. As such, the functions of real-time data management and historical data management may be achieved.

Further, the monitoring center system may be used for comparing operating parameters of same type sent from respective monitoring terminal systems and displaying the comparison results.

Thus, it would be advantage for the monitoring personnel to determine and compare the operating parameters of respective PV power stations, facilitating monitoring personnel's data analysis.

When being implemented, the telecommunication system may be a wireless communication system.

In this way, transmission of the operating parameters may be achieved accessibly at the place where it is not convenient to access to a wired network.

When being implemented, the monitoring center system is further used for receiving equipment controlling commands input by a user and sending the received equipment controlling commands to the monitoring terminal system to which a target equipment is connected.

The monitoring terminal systems are further used for sending the received controlling command to the target equipment.

In this way, the controlling of the respective equipments may be achieved at the monitoring center system, avoiding going to the filed to set each device, reducing the difficulty of device management.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

What is claimed is:

1. A photovoltaic power station remote monitoring system, comprising: a monitoring center system and at least one monitoring terminal system;
each monitoring terminal system is used for collecting operating parameters of a photovoltaic power station to which it belongs, and sending the operating parameters to the monitoring center system via a telecommunication network; and
the monitoring center system is used for receiving and displaying the operating parameters sent from respective monitoring terminal systems.

2. The remote monitoring system according to claim 1, wherein the monitoring terminal systems are used for receiving operating parameters of photovoltaic power stations collected by a plurality of collection equipments via a fieldbus.

3. The remote monitoring system according to claim 1, wherein the monitoring terminal systems are used for sending the collected operating parameters to the monitoring center system with a layer-3 tunnel encryption protocol (IPsec).

4. The remote monitoring system according to claim 1, wherein the monitoring center system is used for displaying the received operating parameters by way of a chart.

5. The remote monitoring system according to claim 1, wherein the monitoring center system is further used for comparing the operating parameters of the same kind which are sent from respective monitoring terminal systems, and displaying results of comparison.

6. The remote monitoring system according to claim 1, wherein the monitoring center system is further used for analyzing the operating parameters sent from respective monitoring terminal systems according to preset analysis rules and displaying results of analysis.

7. The remote monitoring system according to claim 1, wherein the monitoring center system is further used for determining a failure by using the operating parameters sent from respective monitoring terminal systems according to preset failure determination rules and outputting an alarm when it detects a failure.

8. The remote monitoring system according to claim 1, wherein the monitoring center system is further used for receiving operating parameter editing commands input by a user and editing corresponding operating parameters according to the received operating parameters editing commands.

9. The remote monitoring system according to claim 1, wherein the telecommunication system is a wireless communication system.

10. The remote monitoring system according to claim 1,
wherein the monitoring center system is further used for receiving controlling commands to collection equipments input by a user and sending the received controlling commands to the monitoring terminal system to which a target collection equipment is connected; and
the monitoring terminal systems are further used for sending the received controlling command to the target collection equipment.
